(19) United States
(12) Patent Application Publication
(10) Pub. No.: US 2018/0030884 A1
(43) Pub. Date: Feb. 1, 2018

(54) CONTROL DEVICE OF INTERNAL COMBUSTION ENGINE

(71) Applicant: Honda Motor Co.,Ltd., Tokyo (JP)

(72) Inventors: Tadashi KUROTANI, Saitama (JP); Takashi OTOBE, Saitama (JP); Masaki UENO, Saitama (JP); Masaki SUZUKI, Saitama (JP)

(73) Assignee: Honda Motor Co.,Ltd., Tokyo (JP)

(21) Appl. No.: 15/662,263

(22) Filed: Jul. 27, 2017

(30) Foreign Application Priority Data
Jul. 29, 2016 (JP) 2016-149257

(51) Int. Cl. F02B 37/14; F02M 26/04; F02B 37/10; F02M 26/01; F02D 41/00; F02D 13/02

(52) U.S. Cl. CPC F02B 37/14; F02D 41/006; F02D 13/0215; F02B 37/10; F02M 26/01; F02M 26/04; F02B 2037/122

(57) ABSTRACT

Provided is a control device of an internal combustion engine for suppressing variation in the internal EGR amount among cylinders and improving the merchantability. A control device 1 of an internal combustion engine 3 has an ECU 2, wherein the internal combustion engine 3 includes an electric turbocharger 5 and first to fourth cylinders #1 to #4. The ECU 2 sets a target rotation change amount DN#i for a turbine 5b of the electric turbocharger 5 corresponding to each cylinder according to the operation state of the internal combustion engine 3 (Step 35), and controls a TC motor 5c of the electric turbocharger 5 in a control period, which includes an exhaust stroke in one combustion cycle of each cylinder, to match the target rotation change amount DN#i (Step 23).

### CROSS-REFERENCE TO RELATED APPLICATION

This application claims the priority benefit of Japan application serial no. 2016-149257, filed on Jul. 29, 2016. The entirety of the above-mentioned patent application is hereby incorporated by reference herein and made a part of this specification.

### BACKGROUND OF THE INVENTION

### Field of the Invention

The invention relates to a control device of an internal combustion engine, which executes control for suppressing variation in the internal EGR (exhaust gas recirculation) amount among cylinders of a multi-cylinder internal combustion engine.

### Description of Related Art

Patent Literature 1 has disclosed a conventional control device for internal combustion engine. The internal combustion engine is a multi-cylinder internal combustion engine and is equipped with a valve characteristic variable device. The valve characteristic variable device is for changing the lift of an intake valve steplessly, and includes an intake camshaft, a pair of normal intake cam and three-dimensional intake cam provided on the intake camshaft for each cylinder, and a hydraulic actuator that drives the intake camshaft in the axial direction.

The normal intake cam has a general cam profile composed of one main cam crest portion while the three-dimensional intake cam has a cam profile composed of a main cam crest portion and an auxiliary cam crest portion that have different heights. The auxiliary cam crest portion of the three-dimensional intake cam is configured so that the height of the contact portion in contact with the intake valve changes as the intake camshaft is driven in the axial direction by the hydraulic actuator, so as to change the valve timing (maximum lift and valve opening time) of the intake valve. Moreover, the shape of the auxiliary cam crest portion is configured so that the maximum lift of the intake valve generated by the auxiliary cam crest portion has a relatively large value for the purpose of reducing variation in the internal EGR amount among the cylinders.

The control device controls the valve timing of the intake valve subject to the three-dimensional intake cam by driving the hydraulic actuator of the valve characteristic variable device according to the operation state of the internal combustion engine.

### PRIOR ART LITERATURE

### Patent Literature

Patent Literature 1: Japanese Patent Publication No. 2001-123811

### SUMMARY OF THE INVENTION

### Problem to be Solved

The general internal combustion engine has a characteristic that, due to the different passage lengths of the exhaust manifolds of the cylinders, when exhaust pulsation occurs with the opening and closing of the exhaust valve, there is variation in the magnitude (amplitude) of the exhaust pulsation. As a result, variation in the internal EGR amount is inevitable.

Regarding this, the control device of the internal combustion engine disclosed in Patent Literature 1 is intended to reduce variation in the internal EGR amount among the cylinders through the shape of the auxiliary cam crest portion of the three-dimensional intake cam. However, in terms of control of the valve characteristic variable device, the variation in the internal EGR amount among the cylinders cannot be suppressed/reduced and therefore the variation in the internal EGR amount among the cylinders inevitably occurs. The reason is that, in the control of the valve characteristic variable device, the valve timing of the intake valve subject to the auxiliary cam crest portion of the three-dimensional intake cam cannot be controlled individually for each cylinder, and the three-dimensional intake cams of all the cylinders are driven simultaneously in the axial direction by the hydraulic actuator.

According to the control device of Patent Literature 1, since the above-described variation in the internal EGR amount among the cylinders is inevitable, combustion fluctuation or torque fluctuation occurs and impairs the drivability. Consequently, the merchantability declines.

In view of the above, the invention provides a control device for internal combustion engine, which is capable of suppressing variation in the internal EGR amount among the cylinders and improving the merchantability.

### Solution to the Problem

Accordingly, in an embodiment of the invention, a control device 1 of an internal combustion engine 3 is provided. The internal combustion engine 3 includes an exhaust pressure changing mechanism (electric turbocharger 5) capable of changing an exhaust pressure Pex that is a pressure in an exhaust passage 9, and a plurality of cylinders (first to fourth cylinders #1 to #4). The control device 1 includes: an operation amount setting unit (ECU 2, Step 35) setting an operation amount (target rotation change amount DN#i) of the exhaust pressure changing mechanism 1, which is for changing the exhaust pressure Pex, corresponding to each of the cylinders (first to fourth cylinders #1 to #4) according to an operation state of the internal combustion engine 3; and a control unit (ECU 2, Step 23) controlling the exhaust pressure changing mechanism (electric turbocharger 5) during a control period, which includes an exhaust stroke in a combustion cycle of each of the cylinders, so as to reach the operation amount (target rotation change amount DN#i) set corresponding to each of the cylinders.

According to the control device of the internal combustion engine, the operation amount of the exhaust pressure changing mechanism for changing the exhaust pressure is set corresponding to each of the cylinders according to the operation state of the internal combustion engine, and the exhaust pressure changing mechanism is controlled during the control period, which includes the exhaust stroke in one combustion cycle of each cylinder, so as to reach the operation amount set corresponding to each cylinder. In this manner, because the exhaust pressure changing mechanism is controlled to reach the operation amount set for each cylinder, the exhaust pressure for each cylinder can be controlled. Thus, even if the exhaust pulsation varies among the cylinders due to the difference in the length of the exhaust passage, such variation can be suppressed appropriately to suppress variation in the internal EGR amount among the cylinders appropriately. As a result, combustion fluctuation and torque fluctuation can be suppressed and the operability can be improved to improve the merchantability.

In an embodiment of the invention, regarding the control device 1 of the internal combustion engine 3 described above, the exhaust pressure changing mechanism includes an electric turbocharger 5 that includes an electric motor (TC motor 5c), a turbine 5b and a compressor 5a that are drivable by the electric motor (TC motor 5c); the operation amount setting unit sets a rotation change amount (target rotation change amount DN#i) of the turbine 5b as the operation amount; and the control unit controls the electric motor (TC motor 5c) during the control period so as to reach the rotation change amount (target rotation change amount DN#i) of the turbine 5b that is set.

According to the control device of the internal combustion engine, the rotation change amount of the turbine of the electric turbocharger is set corresponding to each cylinder according to the operation state of the internal combustion engine, and the electric motor of the electric turbocharger is controlled during the control period so as to reach the rotation change amount of the turbine set corresponding to each cylinder. In this case, the electric motor of the electric turbocharger has higher responsiveness than motors using hydraulic pressure, air pressure, and mechanical energy as power. Thus, during the control period including the exhaust stroke of each cylinder, the set rotation change amount of the turbine can be achieved quickly and the exhaust pressure can be controlled quickly. Thereby, variation in the internal EGR amount among the cylinders can be precisely suppressed.

In an embodiment of the invention, regarding the control device 1 of the internal combustion engine 3 described above, the operation amount setting unit sets the operation amount according to an operation load region of the internal combustion engine 3, which serves as the operation state of the internal combustion engine 3 (Step 35).

In the case of a general internal combustion engine, the optimum internal EGR amount changes as the operation load region of the internal combustion engine changes. In contrast thereto, according to the control device of the internal combustion engine, the operation amount of the exhaust pressure changing mechanism is set according to the operation load region of the internal combustion engine, so that the optimum internal EGR amount can be secured.

In an embodiment of the invention, regarding the control device 1 of the internal combustion engine 3 described above, the control unit controls the exhaust pressure changing mechanism according to a distance, by which a combustion gas discharged from each of the cylinders travels to reach the exhaust pressure changing mechanism (Steps 33 to 37, 80).

According to the control device of the internal combustion engine, the exhaust pressure changing mechanism is controlled according to the distance by which the combustion gas discharged from each cylinder travels to reach the exhaust pressure changing mechanism. Thus, even if the distances for the combustion gas to reach the exhaust pressure changing mechanism are different among the cylinders, this can be reflected while the exhaust pressure changing mechanism is controlled, so as to more precisely suppress variation in the internal EGR amount among the cylinders.

In an embodiment of the invention, regarding the control device 1 of the internal combustion engine 3 described above, the internal combustion engine 3 further includes a valve timing changing mechanism (variable exhaust cam phase mechanism 8) capable of changing a valve timing of at least one of an exhaust valve and an intake valve, and the control unit controls the exhaust pressure changing mechanism according to a change state (exhaust cam phase CAEX) of the valve timing made by the valve timing changing mechanism (Steps 32 to 39, 78 to 80).

In the case of a general internal combustion engine, when the valve timing of the exhaust valve and/or the intake valve is changed by the valve timing changing mechanism, the internal EGR amount changes accordingly. In contrast thereto, according to the control device of the internal combustion engine, the exhaust pressure changing mechanism is controlled according to the change state of the valve timing made by the valve timing changing mechanism. Thus, the change of the internal EGR amount resulting from the change of the valve timing of the exhaust valve and/or the intake valve can be reflected while the exhaust pressure changing mechanism is controlled, so as to more precisely suppress variation in the internal EGR amount among the cylinders.

### BRIEF DESCRIPTION OF THE DRAWINGS

FIG. 1 is a diagram schematically showing a configuration of the control device and the internal combustion engine using the control device according to an embodiment of the invention.

FIG. 2 is a block diagram showing an electrical configuration of the control device.

FIG. 3 is a flow chart showing the exhaust control process.

FIG. 4 is a diagram showing an example of the map used for determining the operation load region of the internal combustion engine.

FIG. 5 is a flow chart showing the TC motor control process.

FIG. 6 is a flow chart showing the energization parameter calculation process.

FIG. 7 is a flow chart showing the setting process of the calculated cylinder.

FIG. 8 is a diagram showing an example of the map used for calculation of the motor control execution period.

FIG. 9 is a flow chart showing the TC motor operation control process.

FIG. 10 is a diagram for explaining the principle of the TC motor control process.

FIG. 11 is a timing chart showing an example of the control result when the exhaust control process is executed under the condition that the operation load region of the internal combustion engine is in the operation region 1.

FIG. 12 is a timing chart showing an example of the control result when the exhaust control process is executed under the condition that the operation load region of the internal combustion engine is in the operation region 2.

FIG. 13 is a timing chart showing an example of the control result when the exhaust control process is executed under the condition that the operation load region of the internal combustion engine is in the operation region 3.

### DESCRIPTION OF THE EMBODIMENTS

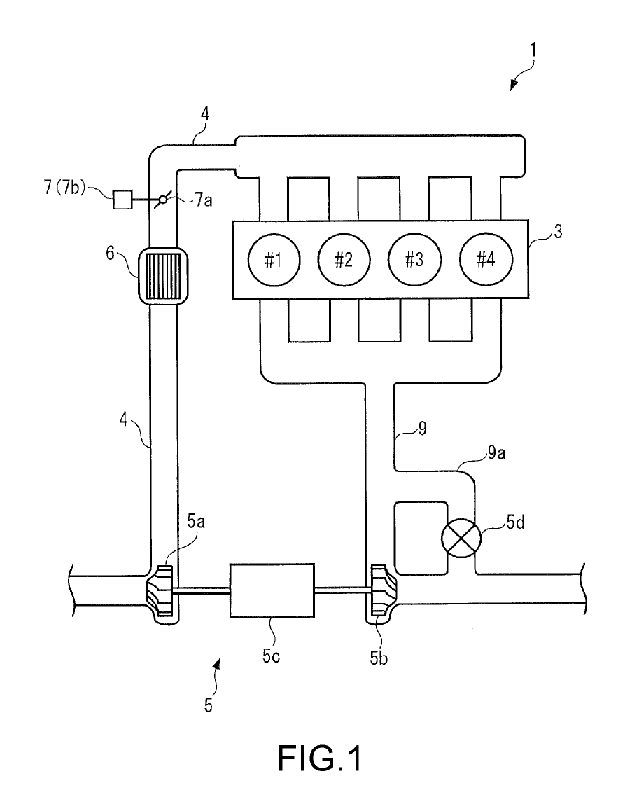

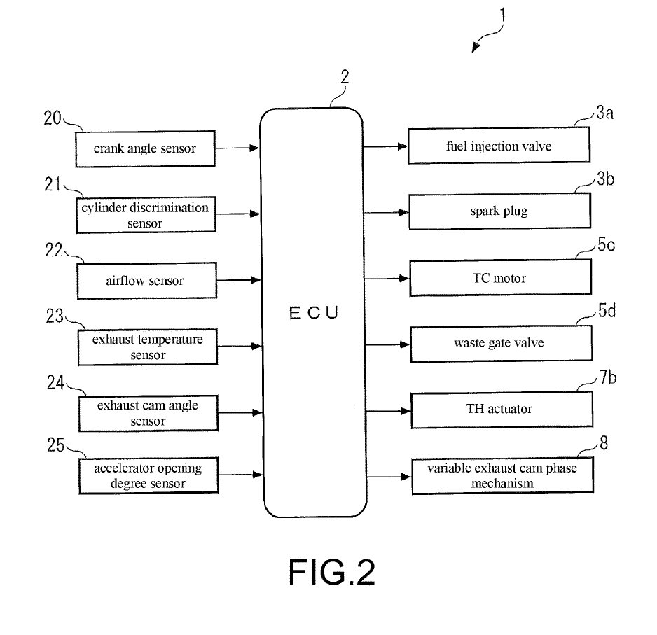

A control device of an internal combustion engine according to an embodiment of the invention is described hereinafter with reference to the figures. A control device 1 shown in FIG. 1 and FIG. 2 is for controlling an operation state of an internal combustion engine 3, an operation state of a turbocharger 5, etc., and includes an ECU (electronic control unit) 2, etc., as shown in FIG. 2. The ECU 2 executes various control processes, such as an exhaust control process, as described later.

The internal combustion engine (referred to as “engine” hereinafter) 3 is an in-line four cylinder gasoline engine mounted on a vehicle (not shown), and is provided with first to fourth cylinders #1 to #4 (a plurality of cylinders). In a cylinder head (not shown) of the engine 3, a fuel injection valve 3a and a spark plug 3b (only one is shown in FIG. 2) are disposed for each cylinder.

The fuel injection valve 3a is electrically connected to the ECU 2, and a fuel injection control process is executed by the ECU 2 to control a fuel injection amount and an injection timing of the fuel injection valve 3a. The spark plug 3b is also electrically connected to the ECU 2, and an ignition timing control process is executed by the ECU 2 to control an ignition timing of the spark plug 3b for an air-fuel mixture.

Further, in an intake passage 4 of the engine 3, a turbocharger with electric assist (referred to as “electric turbocharger” hereinafter) 5, an intercooler 6, a throttle valve mechanism 7, etc., are disposed in order from the upstream side.

The electric turbocharger 5 (exhaust pressure changing mechanism) includes a compressor 5a, a turbine 5b, a TC motor 5c (electric motor), a waste gate valve 5d, etc. The compressor 5a is disposed in the middle of the intake passage 4, and the turbine 5b is disposed on the downstream side of a junction portion of an exhaust manifold of an exhaust passage 9.

Moreover, the TC motor 5c is a DC (direct current) type motor, and the compressor 5a and the turbine 5b are concentrically fixed to two ends of a rotation shaft of the TC motor 5c. In the case of the TC motor 5c, the TC motor 5c is electrically connected to the ECU 2 via a PDU (power distribution unit, not shown), and executes power running control, regeneration control, zero current control, etc., by the ECU 2.

The zero current control is for maintaining a state where no current flows between the TC motor 5c and the PDU (a state of no power transmission). In the following description, the regeneration control and the power running control are collectively referred to as “energization control.”

In the electric turbocharger 5, when the turbine 5b is rotationally driven by an exhaust gas in the exhaust passage 9, the compressor 5a rotates integrally with the turbine 5b, by which an intake gas in the intake passage 4 is pressurized. That is, a supercharging operation is executed.

In addition, when the power running control of the TC motor 5c is executed, the rotation speeds of the turbine 5b and the compressor 5a increase. On the other hand, when the regeneration control of the TC motor 5c is executed, the rotation speeds of the turbine 5b and the compressor 5a decrease. Moreover, when the TC motor 5c is under zero current control, the turbine 5b is rotationally driven only by the thermal energy of the exhaust gas.

Further, the waste gate valve 5d is a combination of a valve body and an electric actuator, and is disposed in the middle of a turbine bypass passage 9a that bypasses the turbine 5b of the exhaust passage 9. The waste gate valve 5d is electrically connected to the ECU 2. When an opening degree of the waste gate valve 5d is controlled by the ECU 2, the flow rate of the exhaust gas that flows through the turbine bypass passage 9a by bypassing the turbine 5b, that is, the flow rate of the exhaust gas that drives the turbine 5b, is changed, so as to change the rotation speed of the turbine 5b, that is, the rotation speed of the compressor 5a. As a result, a supercharging pressure is controlled.

In addition, the intercooler 6 is a water-cooling type cooler, and cools the intake gas that has been heated by the supercharging operation of the electric turbocharger 5 as the intake gas passes through the inside of the intercooler 6.

Besides, the throttle valve mechanism 7 includes a throttle valve 7a, a TH actuator 7b that drives the throttle valve 7a to open and close, etc. The throttle valve 7a is disposed rotatably in the middle of the intake passage 4, and an opening degree thereof changes with the rotation, so as to change the flow rate of the intake gas that passes through the throttle valve 7a.

The TH actuator 7b is formed by combining a gear mechanism 1 with the motor (none of them are shown) connected to the ECU 2, and changes the opening degree of the throttle valve 7a under control of the ECU 2. As a result, the amount of the intake gas flowing into the cylinder, that is, an intake air amount, changes.

The engine 3 is further provided with a variable exhaust cam phase mechanism 8 (refer to FIG. 2). The variable exhaust cam phase mechanism 8 is for changing a relative phase (referred to as “exhaust cam phase” hereinafter) CAEX of an exhaust camshaft (not shown) with respect to a crankshaft (not shown) steplessly to an advanced angle side or a retarded angle side, and is disposed at an end of the exhaust camshaft on the side of an exhaust sprocket (not shown).

More specifically, the variable exhaust cam phase mechanism 8 is configured as the applicant of the present application proposed in Japanese Patent Publication No. 2000-227013, etc., so detailed descriptions thereof are omitted here. The variable exhaust cam phase mechanism 8 is controlled by the ECU 2 to change the exhaust cam phase CAEX continuously between a predetermined most retarded angle value and a predetermined most advanced angle value. Thereby, a valve timing of the exhaust valve is changed steplessly between a most retarded angle timing and a most advanced angle timing.

In the present embodiment, the variable exhaust cam phase mechanism 8 corresponds to the valve timing changing mechanism, and the exhaust cam phase CAEX corresponds to the change state of the valve timing.

Further, as shown in FIG. 2, a crank angle sensor 20, a cylinder discrimination sensor 21, an airflow sensor 22, an exhaust temperature sensor 23, an exhaust cam angle sensor 24, and an accelerator opening degree sensor 25 are electrically connected to the ECU 2.

The crank angle sensor 20 is composed of a magnet rotor and an MRE (magnetic resistance element) pickup, and outputs a CRK signal and a TDC signal, which are pulse signals, to the ECU 2 along with the rotation of the crankshaft. Regarding the CRK signal, one pulse is outputted per crank angle 1°, and the ECU 2 calculates a rotation speed (referred to as “engine rotation speed” hereinafter) NE of the engine 3 based on the CRK signal. In addition, the TDC signal is a signal indicating that a piston of each cylinder is at a predetermined crank angle position slightly before a TDC position of an intake stroke, and one pulse is outputted per predetermined crank angle.

Besides, the cylinder discrimination sensor 21 is disposed in a distributor (not shown) and outputs a cylinder discrimination signal, which is a pulse signal for discriminating the cylinders, to the ECU 2. The ECU 2 calculates a crank angle CA of each of the first to fourth cylinders #1 to #4 based on the cylinder discrimination signal, the CRK signal, and the TDC signal, as described below.

More specifically, the crank angle CA is reset to 0° when the TDC signal of the cylinder is generated and is incremented whenever the CRK signal is generated. As a result, it is calculated such that the crank angle CA of each cylinder is 0° at the TDC position at the beginning of the intake stroke, 180° at the BDC position at the beginning of the compression stroke, 360° at the TDC position at the beginning of the expansion stroke, and 540° at the BDC position at the beginning of the exhaust stroke, and is reset from 720° to 0° when it comes to the TDC position at the beginning of the intake stroke. In the following description, the crank angles CA of the first to fourth cylinders #1 to #4 are referred to as first to fourth crank angles CA#1 to #4 respectively.

Moreover, the airflow sensor 22 is composed of a hot wire airflow meter, and detects a flow rate (referred to as “intake flow rate” hereinafter) GAIR of the intake gas flowing through the intake passage 4 to output a detection signal indicating the intake flow rate GAIR to the ECU 2. The ECU 2 calculates the intake flow rate GAIR based on the detection signal of the airflow sensor 22.

In addition, the exhaust temperature sensor 23 is disposed between the junction portion of the exhaust manifold of the exhaust passage 9 and the portion where the turbine bypass passage 9a diverges from the exhaust passage 9, and detects a temperature (referred to as “exhaust temperature” hereinafter) TEX of the exhaust gas flowing through the exhaust passage 9 to output a detection signal indicating the exhaust temperature TEX to the ECU 2. The ECU 2 calculates the exhaust temperature TEX based on the detection signal of the exhaust temperature sensor 23.

The exhaust cam angle sensor 24 is disposed at an end of the exhaust camshaft on the side opposite to the variable exhaust cam phase mechanism 8, and outputs an exhaust CAM signal, which is a pulse signal, to the ECU 2 per predetermined cam angle (e.g., 1°) along with the rotation of the exhaust camshaft. The ECU 2 calculates the exhaust cam phase CAEX based on the exhaust CAM signal and the CRK signal described above.

Furthermore, the accelerator opening degree sensor 25 detects an accelerator opening degree AP, which is the operation amount of an accelerator pedal (not shown), to output a detection signal indicating the accelerator opening degree AP to the ECU 2. The ECU 2 calculates the accelerator opening degree AP based on the detection signal of the accelerator opening degree sensor 25.

The ECU 2 is composed of a microcomputer including a CPU, a RAM, a ROM, an I/O interface, etc. (none of them are shown), and determines the operation state of the engine 3 according to the detection signals of the aforementioned various sensors 20 to 25 and executes various control processes, as described below, according to the operation state. In the present embodiment, the ECU 2 corresponds to the operation amount setting unit and the control unit.

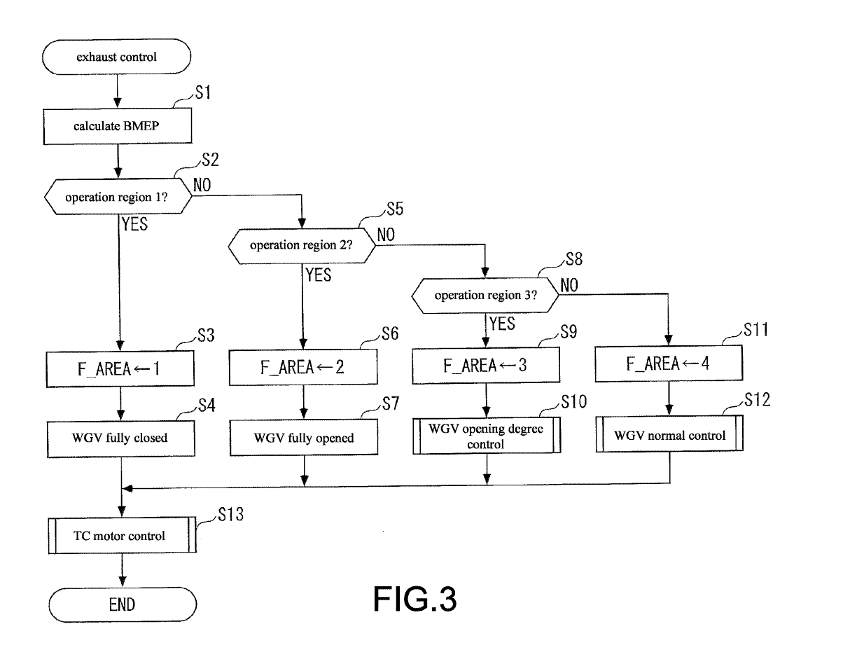

Next, the exhaust control process is described with reference to FIG. 3. As described below, the exhaust control process is for controlling the operation states of the waste gate valve 5d and the TC motor 5c, and is executed by the ECU 2 at a control cycle synchronized with the timing of generation of the CRK signal. Various values calculated in the following description are stored in the RAM of the ECU 2.

As shown in the figure, first, in Step 1 (abbreviated as “S1” in the figure and hereinafter), a brake mean effective pressure BMEP is calculated by searching a map (not shown) according to the engine rotation speed NE and the accelerator opening degree AP.

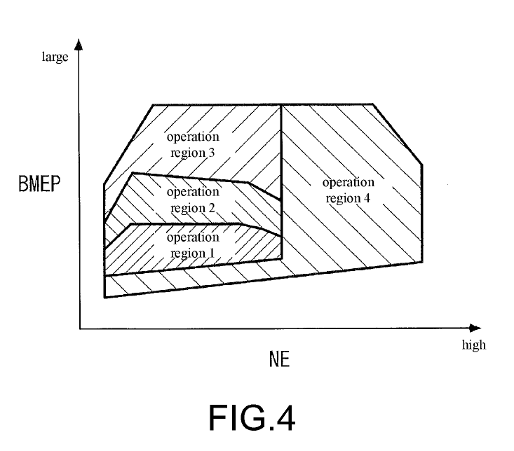

Next, the process proceeds to Step 2, in which whether the operation load region of the engine 3 is in the operation region 1 shown in FIG. 4 is determined. That is, whether a combination of the engine rotation speed NE and the brake mean effective pressure BMEP is in the operation region 1 shown in FIG. 4 is determined with reference to FIG. 4.

If the determination result is YES, the process proceeds to Step 3, in which an operation region flag F_AREA is set to “1” to indicate that the operation load region of the engine 3 is in the operation region 1.

Then, the process proceeds to Step 4, in which the waste gate valve 5d (indicated as “WGV” in the figure) is controlled to be a fully closed state.

On the other hand, if the determination result of Step 2 is NO, the process proceeds to Step 5, in which whether the operation load region of the engine 3 is in the operation region 2 shown in FIG. 4 is determined with reference to FIG. 4 as described above. If the determination result is YES, the process proceeds to Step 6, in which the operation region flag F_AREA is set to “2” to indicate that the operation load region of the engine 3 is in the operation region 2.

Thereafter, the process proceeds to Step 7, in which the waste gate valve 5d is controlled to be a fully opened state.

On the other hand, if the determination result of Step 5 is NO, the process proceeds to Step 8, in which whether the operation load region of the engine 3 is in the operation region 3 shown in FIG. 4 is determined with reference to FIG. 4. If the determination result is YES, the process proceeds to Step 9, in which the operation region flag F_AREA is set to “3” to indicate that the operation load region of the engine 3 is in the operation region 3.

Then, the process proceeds to Step 10, in which an opening degree control process of the waste gate valve 5d is executed. In the case of this control process, although not shown, a target opening degree is calculated by searching a map (not shown) according to the engine rotation speed NE and the brake mean effective pressure BMEP to serve as the target for the opening degree (referred to as “waste gate valve opening degree” hereinafter) of the waste gate valve 5d, and the waste gate valve opening degree is control to reach the target opening degree.

On the other hand, if the determination result of Step 8 is NO, it is determined that the operation load region of the engine 3 is in the operation region 4 shown in FIG. 4, and in order to indicate this, the process proceeds to Step 11 and the operation region flag F_AREA is set to “4.”

Next, the process proceeds to Step 12, in which a normal control process of the waste gate valve 5d is executed. In the case of this control process, although not shown, the target opening degree is calculated by searching a map (not shown) according to the engine rotation speed NE and the brake mean effective pressure BMEP to serve as the target for the waste gate valve opening degree, and the waste gate valve opening degree is control to reach the target opening degree, as in Step 10 described above.

In Step 13 that follows any of the aforementioned Steps 4, 7, 10, and 12, as described below, after the TC motor control process is executed, the exhaust control process ends.

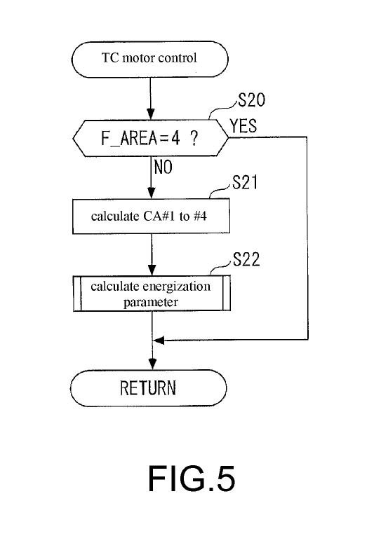

Next, the aforementioned TC motor control process is described with reference to FIG. 5. The TC motor control process is for controlling the operation state of the TC motor 5c, as described below.

As shown in the figure, first, in Step 20, whether the aforementioned operation region flag F_AREA is “4” is determined. If the determination result is YES and the operation load region of the engine 3 is in the operation region 4, the process proceeds to Step 30, and as described above, after the zero current control process of the TC motor 5c is executed, this process ends. Thereby, the TC motor 5c is maintained in the state where no current flows between the TC motor 5c and the PDU.

On the other hand, if the determination result of Step 20 is NO and the operation load region of the engine 3 is in any of the operation regions 1 to 3, the process proceeds to Step 21, in which the first to fourth crank angles CA#1 to #4 are calculated based on the aforementioned crank angle CA, the cylinder discrimination signal, etc.

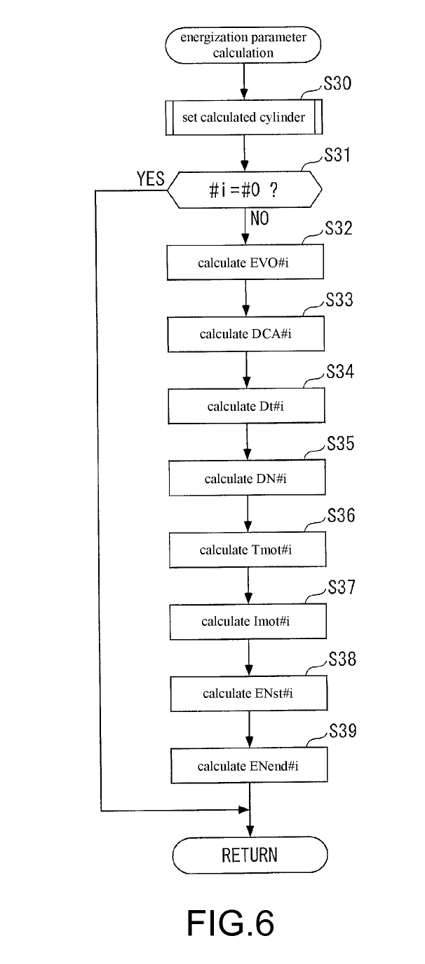

Then, the process proceeds to Step 22, in which an energization parameter calculation process is executed. The energization parameter calculation process is for calculating a control start timing, a control end timing, etc. of the TC motor 5c, and is specifically executed as shown in FIG. 6.

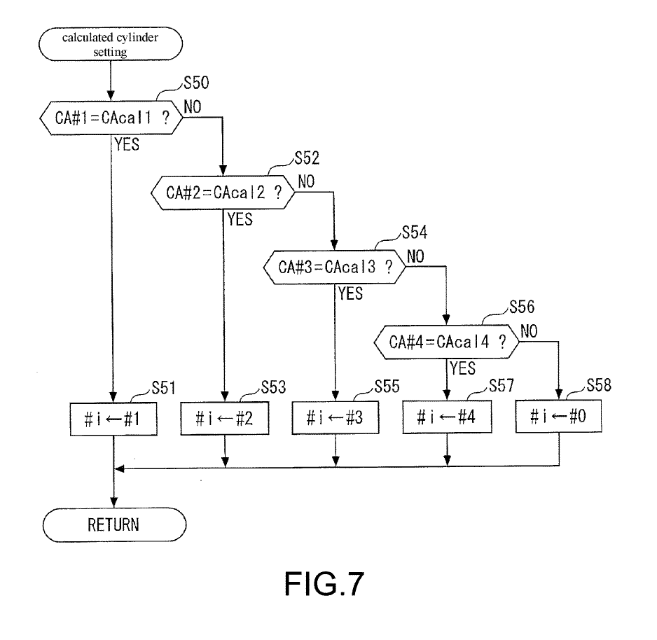

As shown in the figure, first, in Step 30, a setting process of the calculated cylinder is executed. The setting process is for setting the calculated cylinder #i (more specifically, the cylinder number #i thereof) which is the cylinder for which the energization parameter should be calculated, and is specifically executed as shown in FIG. 7.

As shown in the figure, first, in Step 50, whether the first crank angle CA#1 is a calculated crank angle CAcal1 for the first cylinder is determined. The calculated crank angle CAcal1 for the first cylinder is set to the predetermined crank angle at the early stage of the expansion stroke of the first cylinder #1.

If the determination result is YES, it is determined that the energization parameter for the first cylinder should be calculated, and in order to indicate this, the process proceeds to Step 51, and after the cylinder number #i is set to #1, this process ends.

On the other hand, if the determination result of Step 50 is NO, the process proceeds to Step 52, and whether the second crank angle CA#2 is the calculated crank angle CAcal2 for the second cylinder is determined. The calculated crank angle CAcal2 for the second cylinder is set to the predetermined crank angle at the early stage of the expansion stroke of the second cylinder #2.

If the determination result of Step 52 is YES, it is determined that the energization parameter for the second cylinder should be calculated, and in order to indicate this, the process proceeds to Step 53, and after the cylinder number #i is set to #2, this process ends.

On the other hand, if the determination result of Step 52 is NO, the process proceeds to Step 54, and whether the third crank angle CA #3 is the calculated crank angle CAcal3 for the third cylinder is determined. The calculated crank angle CAcal3 for the third cylinder is set to the predetermined crank angle at the early stage of the expansion stroke of the third cylinder #3.

If the determination result of Step 54 is YES, it is determined that the energization parameter for the third cylinder should be calculated, and in order to indicate this, the process proceeds to Step 55, and after the cylinder number #i is set to #3, this process ends.

On the other hand, if the determination result of Step 54 is NO, the process proceeds to Step 56, and whether the fourth crank angle CA#4 is the calculated crank angle CAcal4 for the fourth cylinder is determined. The calculated crank angle CAcal4 for the fourth cylinder is set to the predetermined crank angle at the early stage of the expansion stroke of the fourth cylinder #4.

If the determination result of Step 56 is YES, it is determined that the energization parameter for the fourth cylinder should be calculated, and in order to indicate this, the process proceeds to Step 57 and the cylinder number #i is set to #4.

On the other hand, if the determination result of Step 56 is NO, in order to indicate that calculation of the energization parameter is not required, the process proceeds to Step 58, and after the cylinder number #i is set to #0, this process ends.

Returning to FIG. 6, after the setting process of the calculated cylinder is executed in Step 30 as described above, the process proceeds to Step 31, and whether the cylinder number #i set in Step 30 is #0 is determined. If the determination result is YES and calculation of the energization parameter is not required, this process ends directly.

On the other hand, if the determination result of Step 31 is NO and #i≠#0, the process proceeds to Step 32 and a valve opening timing EVO#i of the exhaust valve of the calculated cylinder #i is calculated by searching a map (not shown) according to the exhaust cam phase CAEX. The valve opening timing EVO#i is calculated as a crank angle CA.

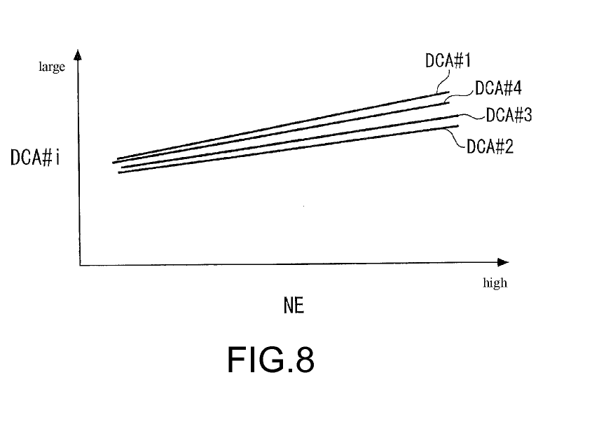

Next, the process proceeds to Step 33, and a motor control execution period DCA#i is calculated by searching the map shown in FIG. 8 according to the engine rotation speed NE. The motor control execution period DCA#i corresponds to the execution period of the energization control process of the TC motor 5c for the calculated cylinder #i, and is calculated as a crank angle CA. In the case of FIG. 8, the motor control execution period DCA#i is set respectively according to a distance by which the combustion gas discharged from the calculated cylinder #i travels to reach the turbine 5b of the electric turbocharger 5.

Next, in Step 34, a motor control execution time Dt#i is calculated by converting the unit of the motor control execution period DCA#i into time based on the engine rotation speed NE.

In Step 35 that follows Step 34, a target rotation change amount DN#i is calculated. The target rotation change amount DN#i (operation amount) is the target value of the change amount of the rotation speed of the turbine 5b. More specifically, the exhaust energy is calculated based on operation parameters such as the ignition timing, the exhaust temperature TEX, the intake flow rate GAIR, and the engine rotation speed NE, and then the target rotation change amount DN#i is calculated based on the exhaust energy and the value of the aforementioned operation region flag F_AREA. In this case, when the operation region flag F_AREA=1, the target rotation change amount DN#i is calculated as a negative value in order to execute the regeneration control of the TC motor 5c; when the operation region flag F_AREA=2, the target rotation change amount DN#i is calculated as a positive value in order to execute the power running control; and when the operation region flag F_AREA=3, the target rotation change amount DN#i is calculated as a positive value and/or a negative value according to the operation state.

Thereafter, the process proceeds to Step 36, and a required motor torque Tmot#i is calculated. The required motor torque Tmot#i is the torque (unit: Nm) that should be generated by the TC motor 5c. More specifically, the required motor torque Tmot#i is calculated by the following equation (1).

Tmot#i=(2π·J·DN#i)/(60·Dt#i) (1)

In the above equation (1), J is a moment of inertia. The required motor torque Tmot#i is respectively calculated as a positive value when the power running control of the TC motor 5c is executed and as a negative value when the regeneration control is executed.

Next, in Step 37, a motor control current Imot#i is calculated by searching a map (not shown) according to the required motor torque Tmot#i. The motor control current Imot#i is respectively calculated as a positive value when the power running control of the TC motor 5c is executed and as a negative value when the regeneration control is executed.

In Step 38 that follows Step 37, a control start timing ENst#i is calculated by the following equation (2). The control start timing ENst#i is the timing to start control of the TC motor 5c and is calculated as a crank angle CA during the exhaust stroke.

ENst#i=EVO#i−DELAY#i (2)

The DELAY#i in the equation (2) is a compensation value (positive value) for compensating for the response delay of the TC motor 5c when controlling the TC motor 5c. In other words, the control current to the TC motor 5c is outputted from the PDU to the TC motor 5c at a timing that is earlier than the valve opening timing EVO#i of the exhaust valve by the compensation value DELAY#i.

Next, the process proceeds to Step 39, after a control end timing ENend#i is calculated by the following equation (3), this process ends. The control end timing ENend#i is the timing to end control of the TC motor 5c and is calculated as a crank angle CA.

ENend#i=ENst#i+DCA#i (3)

In the case of the energization parameter calculation process, when the operation region flag F_AREA=3 and the target rotation change amount DN#i is calculated as both a positive value and a negative value in the aforementioned Step 35, the positive and negative two values are calculated as the motor control current Imot#i in the aforementioned Step 37, and in the aforementioned Step 39, in addition to the control end timing ENend#i, a switching timing of the positive and negative two values of the motor control current Imot#i is calculated as the timing between the control start timing ENst#i and the control end timing ENend#i.

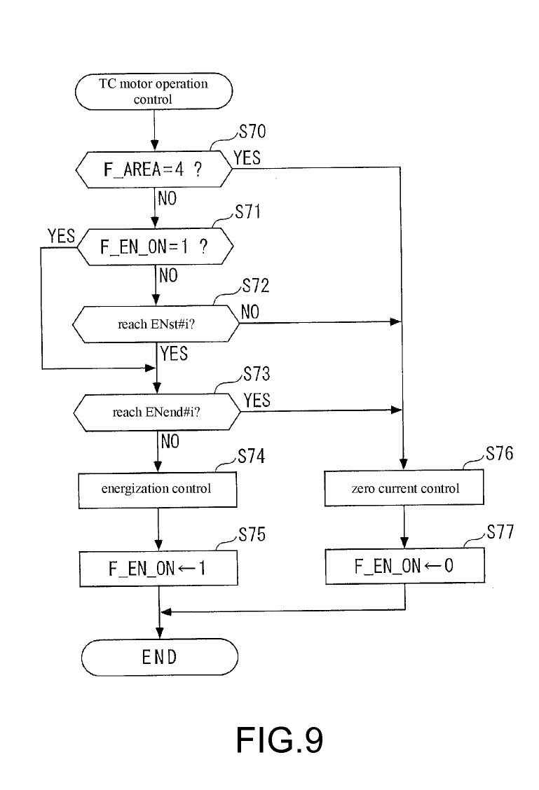

Returning to FIG. 5, after the energization parameter calculation process is executed in Step 22 as described above, the process proceeds to Step 23, and an exhaust cylinder control process is executed. The exhaust cylinder control process is for controlling the TC motor 5c corresponding to the cylinder in the exhaust stroke (referred to as “exhaust cylinder” hereinafter), and is specifically executed as shown in FIG. 9.

As shown in the figure, first, in Step 70, whether the first cylinder #1 is in the exhaust stroke is determined based on the first crank angle CA#1. In this case, the exhaust stroke is a predetermined period of the crank angle CA determined according to the set value of the exhaust cam phase CAEX. If the determination result is YES, it is determined that the exhaust cylinder is the first cylinder #1, and in order to indicate this, the process proceeds to Step 73, and the cylinder number #i of the exhaust cylinder is set to #1.

On the other hand, if the determination result of Step 70 is NO, the process proceeds to Step 71, and whether the second cylinder #2 is in the exhaust stroke is determined based on the second crank angle CA#2. If the determination result is YES, it is determined that the exhaust cylinder is the second cylinder #2, and in order to indicate this, the process proceeds to Step 74, and the cylinder number #i of the exhaust cylinder is set to #2.

On the other hand, if the determination result of Step 71 is NO, the process proceeds to Step 72, and whether the third cylinder #3 is in the exhaust stroke is determined based on the third crank angle CA#3. If the determination result is YES, it is determined that the exhaust cylinder is the third cylinder #3, and in order to indicate this, the process proceeds to Step 75, and the cylinder number #i of the exhaust cylinder is set to #3.

On the other hand, if the determination result of Step 72 is NO, it is determined that the exhaust cylinder is the fourth cylinder #4, and in order to indicate this, the process proceeds to Step 76, and the cylinder number #i of the exhaust cylinder is set to #4.

In Step 77 that follows any of the above Steps 73 to 76, whether an energization control in-progress flag F_EN_ON, as described below, is “1” is determined. If the determination result is YES and the energization control process described below is being executed, the process proceeds to Step 79 as described below.

On the other hand, if the determination result of Step 77 is NO and the energization control process described below is not being executed, the process proceeds to Step 78, and whether the crank angle CA#i of the exhaust cylinder is equal to or larger than the control start timing ENst#i of the exhaust cylinder stored in the RAM is determined.

If the determination result is NO and CA#i<ENst#i is satisfied, it is determined that the energization control process of the TC motor 5c should not be executed, and the process proceeds to Step 82, and similar to the aforementioned Step 24, the zero current control process of the TC motor 5c is executed.

Next, the process proceeds to Step 83, and in order to indicate that the energization control process is not being executed, after the energization control in-process flag F_EN_ON is set to “0,” this process ends.

On the other hand, if the determination result of the aforementioned Step 78 is YES and ENst#i≦CA#i is satisfied, or if the determination result of the aforementioned Step 77 is YES and F_EN_ON=1, the process proceeds to Step 79 and whether CA#i<ENend#i is satisfied is determined.

If the determination result is YES and ENst#i≦CA#i<ENend#i is satisfied, it is determined that the energization control process of the TC motor 5c should be executed, and the process proceeds to Step 80, and the energization control process of the TC motor 5c is executed.

More specifically, the power running control process or the regeneration control process of the TC motor 5c is executed according to whether the motor control current Imot#i calculated in the aforementioned Step 37 is positive or negative. In addition, in the case where the motor control current Imot#i is calculated as both a positive value and a negative value in the aforementioned Step 37 and, in addition to the control end timing ENend#i, the switching timing of the motor control current Imot#i is calculated in the aforementioned Step 39, the power running control process and the regeneration control process of the TC motor 5c are switched at the switching timing to be executed.

Next, the process proceeds to Step 81, in order to indicate that the energization control process is being executed, after the energization control in-process flag F_EN_ON is set to “1,” this process ends. As described above, by executing the energization control process, the TC motor 5c is controlled so that the rotation change amount of the turbine 5b reaches the target rotation change amount DN#i.

On the other hand, if the determination result of Step 79 is NO, that is, if ENst#i≦CA#i is satisfied and the execution period of the energization control process has ended, as described above, after Steps 82 and 83 are executed, this process ends.

Returning to FIG. 5, after the exhaust cylinder control process is executed in Step 23 as described above, the TC motor control process of FIG. 5 ends.

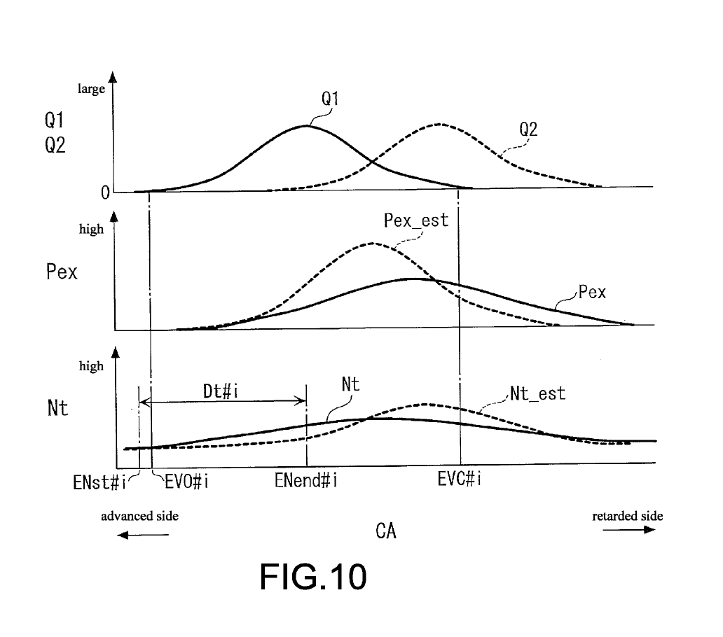

Next, the principle of the TC motor control process of the present embodiment, which is executed as described above, is described with reference to FIG. 10. In the figure, Q1 represents the exhaust flow rate at the exhaust port of the exhaust cylinder #i, and Q2 represents the exhaust flow rate into the turbine 5b. In addition, Pex indicated by a solid line represents the exhaust pressure when the energization control process (more specifically, the power running control process) in the TC motor control process of the present embodiment is executed, and Pex_est indicated by a broken line represents the exhaust pressure at the time of no control when the energization control process is intentionally not executed for comparison.

Moreover, Nt indicated by a solid line represents the turbine rotation speed when the energization control process in the TC motor control process of the present embodiment is executed, and Nt_est indicated by a broken line represents the turbine rotation speed at the time of no control when the energization control process is intentionally not executed for comparison. Further to the above, EVC#i represents the valve closing timing of the exhaust valve of the exhaust cylinder #i.

As shown in the figure, in the case where the energization control process is intentionally not executed, when the crank angle CA reaches the valve opening timing EVO#i of the exhaust valve of the exhaust cylinder #i along with the rotation of the crankshaft, the exhaust flow rate Q1 rises with the increase of the lift of the exhaust valve, and then the exhaust flow rate Q1 decreases with the decrease of the lift of the exhaust valve, and when the crank angle CA reaches the valve closing timing EVC#i, Q1=0.

In the opening and closing operation of the exhaust valve described above, the exhaust flow rate Q2 changes with a dead time, which corresponds to the exhaust passage length of the exhaust cylinder #i, with respect to the exhaust flow rate Q1. On the other hand, the exhaust pressure at the time of no control Pex_est rises at a timing later than the valve opening timing EVO#i of the exhaust valve and then decreases. Consequently, the turbine rotation speed at the time of no control Nt_est also rises at a timing slightly later than the exhaust pressure at the time of no control Pex_est and then decreases.

In contrast thereto, in the case where the energization control process of the present embodiment is executed, the energization control process (more specifically, the power running control process) of the TC motor 5c is started at the control start timing ENst#i, which is earlier than the valve opening timing EVO#i of the exhaust valve by the compensation value DELAY#i, so as to compensate for the response delay of the TC motor 5c. Accordingly, the turbine rotation speed Nt starts to rise gradually in synchronization with the valve opening timing EVO#i of the exhaust valve and continues to rise thereafter. Then, due to the moment of inertia of the turbine 5b and the TC motor 5c, the turbine rotation speed Nt continues to rise for a short period of time even after the energization control process of the TC motor 5c ends at the control end timing ENend#i, and after reaching the maximum value, the turbine rotation speed Nt decreases. In this case, the maximum value of the turbine rotation speed Nt is suppressed to be smaller than the maximum value of the turbine rotation speed at the time of no control Nt_est.

As the turbine rotation speed Nt changes in the manner described above, the exhaust pressure Pex changes with the fluctuation range (amplitude) suppressed, in comparison with the exhaust pressure at the time of no control Pex_est. Accordingly, by executing the above energization control process on each cylinder, the exhaust pulsation among the cylinders can be suppressed to suppress variation in the internal EGR amount among the cylinders.

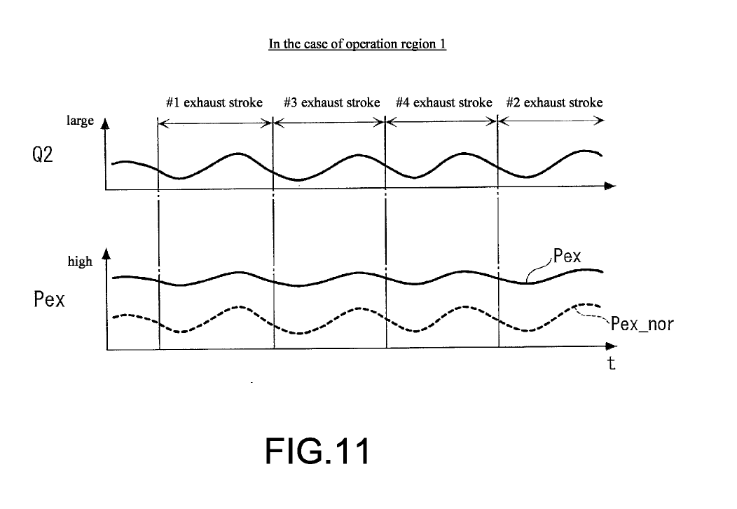

Next, an example of the control result of executing the exhaust control process by the control device 1 of the present embodiment is described with reference to FIG. 11 to FIG. 13. In FIG. 11 to FIG. 13, Pex_nor indicated by a broken line represents the exhaust pressure at the time of normal control when the exhaust control process of the present embodiment is intentionally not executed for comparison.

First, as shown in FIG. 11, when the operation load region of the engine 3 is in the operation region 1, due to the control for setting the waste gate valve 5d to the fully closed state and the regeneration control process of the TC motor 5c, the exhaust pressure Pex at the time when the exhaust control process is executed is controlled to be on the high pressure side as a whole, as compared with the exhaust pressure at the time of normal control Pex_nor. It is to raise the exhaust pressure Pex, so as to improve the thermal efficiency by the increase of the internal EGR amount.

Furthermore, in the regeneration control process of the TC motor 5c, the power regeneration amount of the TC motor 5c is controlled to increase in accordance with the increase of the exhaust pressure Pex and controlled to decrease in accordance with the decrease of the exhaust pressure Pex during fluctuation of the exhaust pressure Pex. As a result, the amplitude, i.e., the exhaust pulsation, of the exhaust pressure Pex is suppressed as compared with the exhaust pressure at the time of normal control Pex_nor. It is to suppress the exhaust pulsation, so as to suppress variation in the internal EGR amount among the cylinders.

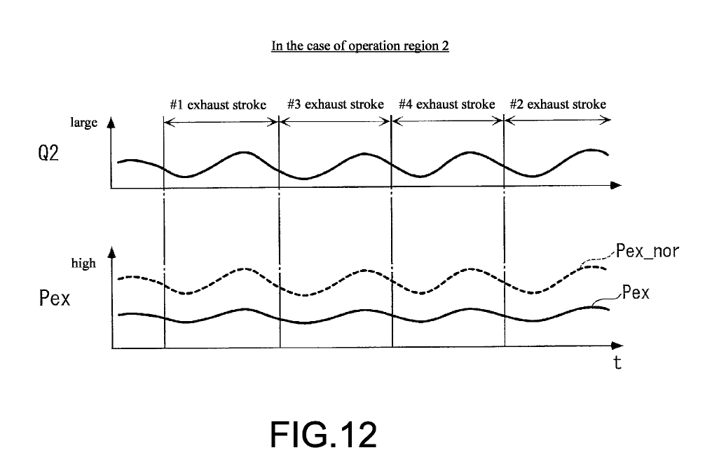

In addition, as shown in FIG. 12, when the operation load region of the engine 3 is in the operation region 2, due to the control for setting the waste gate valve 5d to the fully opened state and the power running control process of the TC motor 5c, the exhaust pressure Pex at the time when the exhaust control process is executed is controlled to be on the low pressure side as a whole, as compared with the exhaust pressure at the time of normal control Pex_nor. It is to lower the exhaust pressure Pex to lower the internal EGR amount, so as to reduce the compression start temperature and thereby suppress occurrence of knocking and improve the thermal efficiency.

Furthermore, in the power running control process of the TC motor 5c, the rotation speed of the TC motor 5c is controlled to increase in accordance with the increase of the exhaust pressure Pex and controlled to decrease in accordance with the decrease of the exhaust pressure Pex during fluctuation of the exhaust pressure Pex. As a result, the amplitude, i.e., the exhaust pulsation, of the exhaust pressure Pex is suppressed as compared with the exhaust pressure at the time of normal control Pex_nor. As described above, it is to suppress the exhaust pulsation, so as to suppress variation in the internal EGR amount among the cylinders.

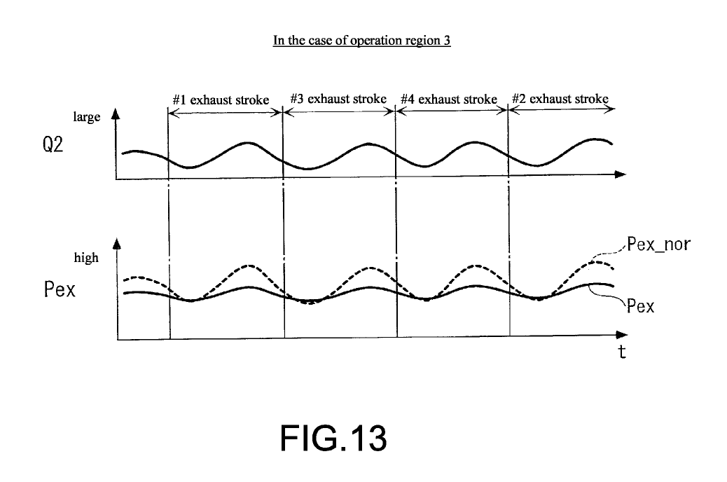

On the other hand, as shown in FIG. 13, when the operation load region of the engine 3 is in the operation region 3, due to the energization control process of the TC motor 5c, the amplitude, i.e., the exhaust pulsation, of the exhaust pressure Pex at the time when the exhaust control process is executed is suppressed as compared with the exhaust pressure at the time of normal control Pex_nor. As described above, it is to suppress the exhaust pulsation, so as to suppress variation in the internal EGR amount among the cylinders.

In the case of the control result shown in FIG. 13, both the power running control process and the regeneration control process of the TC motor 5c are executed as the energization control process of the TC motor 5c, while the power running control process of the TC motor 5c is executed in accordance with the increase of the exhaust pressure Pex during fluctuation of the exhaust pressure Pex. Moreover, the regeneration control process of the TC motor 5c is executed in accordance with the decrease of the exhaust pressure Pex.

According to the control device 1 of the present embodiment, as described above, in the TC motor control process, the valve opening timing EVO#i of the exhaust valve of the calculated cylinder #i is calculated according to the exhaust cam phase CAEX, the motor control execution period DCA#i is calculated according to the engine rotation speed NE, and the control start timing ENst#i and the control end timing ENend#i of the TC motor 5c are calculated based on the valve opening timing EVO#i and the motor control execution period DCA#i.

Further, the operation region flag F_AREA is set according to the operation load region of the engine 3, the target rotation change amount DN#i is calculated based on the operation region flag F_AREA and the exhaust energy, the required motor torque Tmot#i is calculated based on the motor control execution time Dt#i obtained by converting the motor control execution period DCA#i into time and the target rotation change amount DN#i, and the motor control current Imot# is calculated according to the required motor torque Tmot#i. Then, for the exhaust stroke cylinder #i, the power running control process and/or the regeneration control process of the TC motor 5c are executed based on the motor control current Imot#i, the control start timing ENst#i, and the control end timing ENend#i calculated as described above. Thereby, the TC motor 5c is controlled so that the rotation change amount of the turbine 5b reaches the target rotation change amount DN#i.

As described above, because of execution of the TC motor control process, the exhaust pressure Pex for each cylinder can be controlled. Thus, even if the exhaust pulsation varies among the cylinders due to the difference in the length of the exhaust passage from the exhaust port to the turbine 5b, such variation can be suppressed appropriately. Consequently, variation in the internal EGR amount among the cylinders can be suppressed appropriately to suppress combustion fluctuation and torque fluctuation and improve the operability. As a result, the merchantability can be improved.

Moreover, because the target rotation change amount DN#i is calculated based on the operation region flag F_AREA and the exhaust energy, as the operation load region changes, the change of the optimum internal EGR amount can be reflected while the target rotation change amount DN#i is calculated. By using such target rotation change amount DN#i to control the TC motor 5c, the optimum internal EGR amount can be secured.

Furthermore, the TC motor 5c of the electric turbocharger 5 has higher responsiveness than motors using hydraulic pressure, air pressure, and mechanical energy as power. Thus, for the exhaust stroke cylinder #i, the target rotation change amount DN#i can be achieved quickly and the exhaust pressure Pex can be controlled quickly. Thereby, variation in the internal EGR amount among the cylinders can be precisely suppressed.

Besides, because the control start timing ENst#i and the control end timing ENend#i are calculated according to the exhaust cam phase CAEX, even if the change of the exhaust cam phase CAEX and the change of the opening and closing timings of the exhaust valve cause the internal EGR amount to change, the TC motor 5c can be controlled at an appropriate timing corresponding thereto. Thereby, variation in the internal EGR amount among the cylinders can be more precisely suppressed.

The embodiments illustrate an example of using the electric turbocharger 5 as the exhaust pressure changing mechanism, but the exhaust pressure changing mechanism of the invention is not limited thereto. Any mechanism capable of changing the pressure in the exhaust passage may be used instead. For example, for an internal combustion engine that has a normal turbocharger, an electric power turbine serving as the exhaust pressure changing mechanism may be disposed in parallel to or in series with the turbine of the turbocharger in the exhaust passage.

In addition, the embodiments illustrate an example of using the target rotation change amount DN#i as the operation amount of the exhaust pressure changing mechanism, but the operation amount of the invention is not limited thereto. Any value corresponding to the operation amount of the exhaust pressure changing mechanism may be used instead. For example, in the case of using an electric power turbine as the exhaust pressure changing mechanism, the rotation change amount of the power turbine may be used.

Further, the embodiments illustrate an example of using the variable exhaust cam phase mechanism 8 as the valve timing changing mechanism, but the valve timing changing mechanism of the invention is not limited thereto. Any mechanism capable of changing the valve timing of at least one of the exhaust valve and the intake valve may be used instead. For example, in addition to the variable exhaust cam phase mechanism 8, a variable intake cam phase mechanism, which changes the relative phase (referred to as “intake cam phase” hereinafter) of the intake camshaft with respect to the crankshaft to the advanced side or the retarded side steplessly, may be used as the valve timing changing mechanism. Thus, when the variable exhaust cam phase mechanism 8 and the variable intake cam phase mechanism are both used, the TC motor control may be executed according to the exhaust cam phase CAEX and the intake cam phase, and when only the variable intake cam phase mechanism is used, the TC motor control may be executed according to the intake cam phase.

The embodiments illustrate an example of calculating the control start timing ENst#i to serve as the crank angle CA during the exhaust stroke. Nevertheless, the control start timing ENst#i may also be calculated to serve as the timing (crank angle CA) of the latter stage of the expansion stroke. In that case, Step 70 to Step 72 may be performed for determining whether the first to third cylinders are between the timing of the latter stage of the expansion stroke and the timing of the latter stage of the exhaust stroke (the timing including the end time).

Moreover, although the embodiments illustrate examples of using the control device of the invention on an internal combustion engine for vehicle, application of the control device of the invention is not limited thereto. The control device of the invention is also applicable to internal combustion engines for ships or other industrial equipment.

What is claimed is:

1. A control device of an internal combustion engine, which comprises an exhaust pressure changing mechanism and a plurality of cylinders, wherein the exhaust pressure changing mechanism is capable of changing an exhaust pressure that is a pressure in an exhaust passage, the control device comprising:
an operation amount setting unit setting an operation amount of the exhaust pressure changing mechanism, which is for changing the exhaust pressure, corresponding to each of the cylinders according to an operation state of the internal combustion engine; and
a control unit controlling the exhaust pressure changing mechanism during a control period, which comprises an exhaust stroke in a combustion cycle of each of the cylinders, so as to reach the operation amount set corresponding to each of the cylinders.

2. The control device of the internal combustion engine according to claim 1, wherein the exhaust pressure changing mechanism comprises an electric turbocharger comprising an electric motor, a turbine and a compressor that are drivable by the electric motor,
the operation amount setting unit sets a rotation change amount of the turbine as the operation amount, and
the control unit controls the electric motor during the control period so as to reach the rotation change amount of the turbine that is set.

3. The control device of the internal combustion engine according to claim 1, wherein the operation amount setting unit sets the operation amount according to an operation load region of the internal combustion engine, which serves as the operation state of the internal combustion engine.

4. The control device of the internal combustion engine according to claim 1, wherein the control unit controls the exhaust pressure changing mechanism according to a distance, by which a combustion gas discharged from each of the cylinders travels to reach the exhaust pressure changing mechanism.

5. The control device of the internal combustion engine according to claim 1, wherein the internal combustion engine further comprises a valve timing changing mechanism capable of changing a valve timing of at least one of an exhaust valve and an intake valve, and
the control unit controls the exhaust pressure changing mechanism according to a change state of the valve timing made by the valve timing changing mechanism.

6. The control device of the internal combustion engine according to claim 2, wherein the operation amount setting unit sets the operation amount according to an operation load region of the internal combustion engine, which serves as the operation state of the internal combustion engine.

7. The control device of the internal combustion engine according to claim 2, wherein the control unit controls the exhaust pressure changing mechanism according to a distance, by which a combustion gas discharged from each of the cylinders travels to reach the exhaust pressure changing mechanism.

8. The control device of the internal combustion engine according to claim 3, wherein the control unit controls the exhaust pressure changing mechanism according to a distance, by which a combustion gas discharged from each of the cylinders travels to reach the exhaust pressure changing mechanism.

9. The control device of the internal combustion engine according to claim 6, wherein the control unit controls the exhaust pressure changing mechanism according to a distance, by which a combustion gas discharged from each of the cylinders travels to reach the exhaust pressure changing mechanism.

10. The control device of the internal combustion engine according to claim 2, wherein the internal combustion engine further comprises a valve timing changing mechanism capable of changing a valve timing of at least one of an exhaust valve and an intake valve, and
the control unit controls the exhaust pressure changing mechanism according to a change state of the valve timing made by the valve timing changing mechanism.

11. The control device of the internal combustion engine according to claim 3, wherein the internal combustion engine further comprises a valve timing changing mechanism capable of changing a valve timing of at least one of an exhaust valve and an intake valve, and
the control unit controls the exhaust pressure changing mechanism according to a change state of the valve timing made by the valve timing changing mechanism.

12. The control device of the internal combustion engine according to claim 4, wherein the internal combustion engine further comprises a valve timing changing mechanism capable of changing a valve timing of at least one of an exhaust valve and an intake valve, and
the control unit controls the exhaust pressure changing mechanism according to a change state of the valve timing made by the valve timing changing mechanism.

13. The control device of the internal combustion engine according to claim 6, wherein the internal combustion engine further comprises a valve timing changing mechanism capable of changing a valve timing of at least one of an exhaust valve and an intake valve, and
the control unit controls the exhaust pressure changing mechanism according to a change state of the valve timing made by the valve timing changing mechanism.

14. The control device of the internal combustion engine according to claim 7, wherein the internal combustion engine further comprises a valve timing changing mechanism capable of changing a valve timing of at least one of an exhaust valve and an intake valve, and
the control unit controls the exhaust pressure changing mechanism according to a change state of the valve timing made by the valve timing changing mechanism.

15. The control device of the internal combustion engine according to claim 8, wherein the internal combustion engine further comprises a valve timing changing mechanism capable of changing a valve timing of at least one of an exhaust valve and an intake valve, and
the control unit controls the exhaust pressure changing mechanism according to a change state of the valve timing made by the valve timing changing mechanism.

16. The control device of the internal combustion engine according to claim 9, wherein the internal combustion engine further comprises a valve timing changing mechanism capable of changing a valve timing of at least one of an exhaust valve and an intake valve, and
the control unit controls the exhaust pressure changing mechanism according to a change state of the valve timing made by the valve timing changing mechanism.
